(19) United States
(12) Patent Application Publication
(10) Pub. No.: US 2016/0284157 A1
(43) Pub. Date: Sep. 29, 2016

(54) SYSTEMS AND METHODS FOR MULTI-MEDIA CONTENT SHARING AND MANAGEMENT

(71) Applicant: Rivalfly National Network, LLC, Chicago, IL (US)

(72) Inventors: Allen J. Marrinson, Chicago, IL (US); Albert I. Goodman, Chicago, IL (US); John Lucas McFeature, Denver, CO (US)

(21) Appl. No.: 15/076,864

(22) Filed: Mar. 22, 2016

Related U.S. Application Data
(60) Provisional application No. 62/136,726, filed on Mar. 23, 2015.

(51) Int. Cl. G07F 17/32

(52) U.S. Cl. CPC G07F 17/323; G07F 17/3276

(57) ABSTRACT

Methods and systems for allowing players to interactively play a game in real-time in a virtual gaming venue are disclosed. The players can interact with each other while playing the game in the venue on their computing devices. Further, players in the venue can play a separate instance of the game concurrently without effecting other players. The method includes gathering a scoring data for the players during a game play in the venue. The scoring data of the players may be used to compute a leaderboard data. The method also includes displaying the leaderboard data at the computing devices in real-time, and aggregating the scoring data of each player for multiple games played by the players. The method includes aggregating the scoring data of each player for a pre-defined time interval such as, weekly, monthly, yearly, and so forth, and using the aggregated scoring data of players for gaming contests.

### TECHNICAL FIELD

The presently disclosed embodiments relate to the field of managing multi-media content in a network. More specifically, embodiments of the present disclosure relate to gaming systems and methods facilitating creation of an interactive gaming environment for players or users to play games and compete with other players on their computing devices.

### BACKGROUND

With the advent of the Internet®, the people all around the world remain connected to each other for both business and personal uses. The people may use computing devices such as, mobile phones, smart phones, tablet computer, computer, laptops, and so forth, to communicate or interact with each other in a network. Further, people may also use their computing devices to share and boast their capabilities and to pursue their hobbies for example, for playing games. Further, with growing popularity of social networking platforms, such as Facebook®, Twitter®, etc., there is a scope of convergence of the multi-media content with the interactive gaming. This may allow the people to boast their capabilities and analytical skills by proving their excellence with their friends in real-time. Further, with this convergence the interactive gaming techniques can be re-vitalized.

### SUMMARY

The present disclosure provides a multi-media content management system for enabling a number of players to interactively play at least one game with each other in real-time on a number of computing devices associated with the plurality of players. The system includes a venue management device configured to manage a plurality of virtual gaming venues including at least one lobby. The at least one lobby may enable the players to play the at least one game on the computing devices. The system also includes player interaction management device configured to enable the players to interact and compete with each other while playing the at least one game in at least one virtual gaming venue of the plurality of virtual gaming venues. The system also includes a game management device configured to allow the players present in the at least one virtual gaming venue to play a separate instance of the at least one game concurrently. The system further includes a score management device configured to manage scoring data of the players by gathering a game score for each of the players during playing of the at least one game; compute a leaderboard data based on the managed scoring data, wherein the leaderboard data includes an arrangement of the players in at least one of an ascending and a descending order based on the game score of each of the players; and aggregate a game score of the each of the players for a number of games played by the players on the computing devices. The system also includes a presentation device configured to display a graphical user interface at a display of the computing devices for playing of the at least one game. The presentation device is also configured to display the leaderboard data at the display of the computing devices associated with each of the players in real-time. Further, the system includes a contest management device for managing the aggregated scoring data of each of the players for at least one gaming contest. The at least one gaming contest involves one or more players of the players.

Another embodiment of the present disclosure provides a method for enabling a number of players to interactively play at least one game in real-time on a number of computing devices associated with the players. The method includes managing, by a venue management device, a number of virtual gaming venues including at least one lobby. The at least one lobby may enable the players to play the at least one game on the computing devices. The method also includes enabling, by a player interaction management device, the players to interact and compete with each other while playing the at least one game in at least one virtual gaming venue of the virtual gaming venues. The method further includes displaying, by a presentation device, a graphical user interface at a display of the computing devices for playing of the at least one game. The method further includes allowing, by a game management device, the players present in the at least one virtual gaming venue to play a separate instance of the at least one game concurrently. The method also includes managing, by a score management device, scoring data of the players by gathering a game score for each of the players during playing of the at least one game. The method further includes computing, by the score management device, a leaderboard data based on the managed scoring data. The leaderboard data may include an arrangement of the players in at least one of an ascending and a descending order based on the game score of each of the players. The method further includes aggregating, by the score management device, a game score of the each of the players for a number of games played by the players on the computing devices. The method also includes displaying, by the presentation device, the leaderboard data at the display of the computing device associated with each of the plurality of players in real-time; and managing, by a contest management device, the aggregated scoring data of each of the plurality of players for at least one gaming contest. The at least one gaming contest may involve one or more players of the number of players.

In another embodiment, a method for presenting interactive multi-media content to one or more users in a network. The method includes presenting, by a presentation device, near real-time content on a number of computing devices associated with the one or more users. The multi-media content may include advertisements, game updates, and scoring data of multiple users. The method also includes presenting, by the presentation device, isolated and unique gaming content for a number of virtual gaming venues including at least one lobby where a number of games being played or accessed by the users on the computing devices. The at least one lobby may be a digital waiting area where the users are grouped up to play a game of the games. One or more of the users present in one of the virtual gaming venues plays at least one game with other users present within the same virtual gaming venue.

In yet another embodiment, multi-media interactive content presentation system is disclosed. The multi-media interactive content presentation system includes a presentation device configured to present near real-time content on a number of computing devices associated with a number of users. The presentation device is also configured to present isolated and unique gaming content for a number of virtual gaming venues including at least one lobby where a number of games being played or accessed by the users on the computing devices. The at least one lobby may be a digital waiting area where the users are grouped up to play a game of the games. One or more of the users present in one of the virtual gaming venues plays at least one game with other users present within the same virtual gaming venue.

### BRIEF DESCRIPTION OF THE DRAWINGS

Non limiting and non exhaustive embodiments of the present invention are described with reference to the following drawings. In the drawings, like reference numerals refer to like parts throughout the various figures unless otherwise specified.

For a better understanding of the present invention, reference will be made to the following Detailed Description, which is to be read in association with the accompanying drawings, wherein:

FIG. 1 illustrates an exemplary environment for managing multi-media content on multiple computing devices in a network, in accordance with an embodiment of the present disclosure;

FIG. 2 illustrates another exemplary environment for managing multi-media content on multiple computing devices in a network, in accordance with another embodiment of the present disclosure;

FIG. 3 is a block diagram that illustrates structural components of an exemplary multi-media content management device, in accordance with an embodiment of the present disclosure;

FIG. 4 is a block diagram that illustrates structural components of another exemplary multi-media content management device, in accordance with another embodiment of the present disclosure;

FIGS. 5A-5C is a flowchart illustrating a method enabling a number of players to interactively play at least one game in real-time on a number of computing devices associated with the players, in accordance with an embodiment of the present disclosure and

FIG. 6 is a flowchart illustrating a method for presenting interactive multi-media content to one or more users in a network, in accordance with an embodiment of the present disclosure.

The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). To facilitate understanding, like reference numerals have been used, where possible, to designate like elements common to the figures.

### DETAILED DESCRIPTION

The presently disclosed subject matter is described with specificity to meet statutory requirements. However, the description itself is not intended to limit the scope of this patent. Rather, the inventors have contemplated that the claimed subject matter might also be embodied in other ways, to include different steps or elements similar to the ones described in this document, in conjunction with other present or future technologies. Moreover, although the term “step” may be used herein to connote different aspects of methods employed, the term should not be interpreted as implying any particular order among or between various steps herein disclosed unless and except when the order of individual steps is explicitly described.

Reference throughout this specification to “a select embodiment,” “one embodiment,” or “an embodiment” means that a particular feature, structure, or characteristic described in connection with the embodiment is included in at least one embodiment of the disclosed subject matter. Thus, appearances of the phrases “a select embodiment,” “in one embodiment,” or “in an embodiment” in various places throughout this specification are not necessarily referring to the same embodiment.

Furthermore, the described features, structures, or characteristics may be combined in any suitable manner in one or more embodiments. In the following description, numerous specific details are provided, to provide a thorough understanding of embodiments of the disclosed subject matter. One skilled in the relevant art will recognize, however, that the disclosed subject matter can be practiced without one or more of the specific details, or with other methods, components, materials, etc. In other instances, well-known structures, materials, or operations are not shown or described in detail to avoid obscuring aspects of the disclosed subject matter.

All numeric values are herein assumed to be modified by the term “about,” whether or not explicitly indicated. The term “about” generally refers to a range of numbers that one of skill in the art would consider equivalent to the recited value (i.e., having the same or substantially the same function or result). In many instances, the terms “about” may include numbers that are rounded to the nearest significant figure.

The recitation of numerical ranges by endpoints includes all numbers within that range (e.g., 1 to 5 includes 1, 1.5, 2, 2.75, 3, 3.80, 4, and 5).

As used in this specification and the appended claims, the singular forms “a,” “an,” and “the” include or otherwise refer to singular as well as plural referents, unless the content clearly dictates otherwise. As used in this specification and the appended claims, the term “or” is generally employed to include “and/or,” unless the content clearly dictates otherwise.

The following detailed description should be read with reference to the drawings, in which similar elements in different drawings are identified with the same reference numbers. The drawings, which are not necessarily to scale, depict illustrative embodiments and are not intended to limit the scope of the disclosure.

### Overview

The present disclosure provides a multi-media content managing methods and systems for allowing a number of players to interactively share multi-media content in a network. In some embodiments, the multi-media content managing system allows the players (or users) to play a game with each other in real-time in a virtual gaming venue or environment. The gaming content of multiple players is managed by a multi-media content management system. Each of the players may access the virtual gaming venue on their associated computing device. The virtual gaming venue may be a virtual environment that may be available to the players for playing one or more games in a network. The players can interact with each other while playing the game in the virtual gaming venue. Further, each of the players present in the virtual gaming venue can play a separate instance of the game concurrently without effecting other players. The method also includes gathering a scoring data for each of the players during a game play in the virtual gaming venue. The scoring data of the players may be used to compute a leaderboard data. The leaderboard data may arrange the players in an ascending or descending order based on their scoring data. The leaderboard data may also indicate the players who are lagging behind in the game play, and who are ahead of other players. The method may also include displaying the leaderboard data at a display of each of the computing devices in real-time. The method may also include aggregating the scoring data of each player for multiple games played by the each player on the computing device. The method may include aggregating the scoring data of each player for a pre-defined time interval such as, weekly, monthly, yearly, and so forth. The method may also include using the aggregated scoring data of each player for one or more gaming contests. The gaming contests may involve more than one player. The gaming contests may include weekly contests, monthly contests, and so forth.

### Exemplary Embodiments

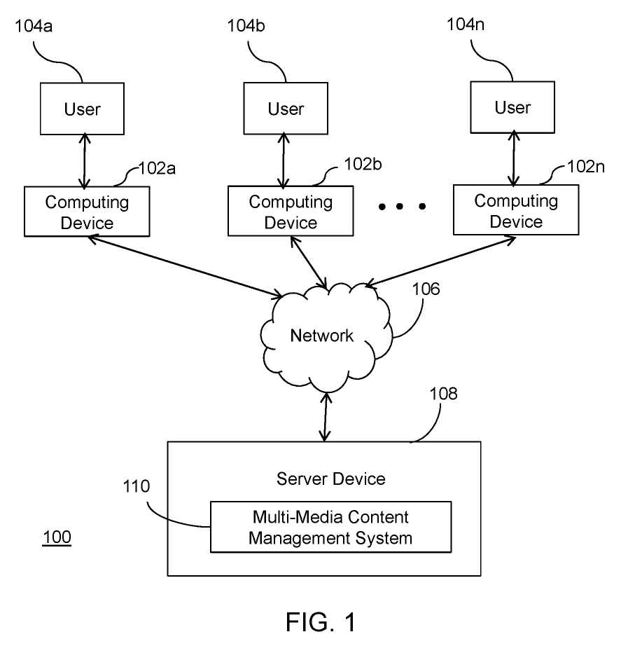

FIG. 1 illustrates an exemplary environment 100 for managing multi-media content on multiple computing devices 102a-102b in a network 106, in accordance with an embodiment of the present disclosure. The environment 100 primarily includes a server device 108, and a number of users or players 104a-104n having an associated computing device of the computing devices 102a-102n. Examples of the computing devices 102a-102n may include, but are not limited to, personal computers, mobile cellular phones, smart phones, tablet computers, laptop computers, and so forth. The server device 108 may also include a multi-media content management system or device 110 for allowing a number of players or users 104a-104n to interactively play a game with each other in real-time in a virtual gaming venue. The users 104a-104n can access the multi-media content management system 110 via the network 106. Hereinafter, the users 104a-104n may be collectively referred as users 104 or players 104.

The multi-media content management system or device 110 may be a software, hardware, firmware, or combination of these. Further, the multi-media content management system or device 110 may include multiple processors or hardware devices.

The multi-media content management system or device 110 may be configured to manage multiple virtual gaming venues including at least one lobby where multiple players or users 104a-104n can play at least one game. The lobby may be a digital waiting area where the users 104a-104n are grouped up to play a game. The lobby may allow a set of players/users 104a-104n to play a same game at the same time and to compete with each other for the highest score. Each of the lobby may cycle through different games, with periods of breaks in between each lobby session. A lobby session may represent a single period of time where the users 104a-104n may play a single game and compete against each other. In some embodiments, lobbies may be unique per location and may exist for each virtual gaming venue. Each of the players or users 104a-104n can access one or more of the virtual gaming venues on their associated computing device 102. The virtual gaming venue is a virtual environment, which is available to the players or users 104a-104n for playing at least one game in the network 106.

The multi-media content management system or device 110 is further configured to represent each of the players 104 (which are playing a game) using at least one virtual player in the at least one lobby. In an embodiment, the at least one virtual player is a pre-defined virtual player and the players 104 selects the at least one virtual player in real-time. The multi-media content management system or device 110 is further configured to capture behavioral data of the at least one virtual player being controlled by each of the players/users 104 during the playing of the at least one game based on a response of each of the plurality players/users 104 in at least one virtual situation presented during the playing of the at least one game. The multi-media content management system or device 110 is further configured to analyze the captured behavioral data of the at least one virtual player to identify a player profile for the at least one virtual player. The player profile may be associated with the players 104 and the player profile may be different for each of the players 104. The multi-media content management system or device 110 is further configured to change a virtual gaming venue on at least one graphical user interface of at least one of the computing devices 102a-102n during playing of the at least one game in real-time based on the identified player profile for the at least one virtual player.

The multi-media content management system or device 110 may also be configured to allow the players 104 to interact and compete with each other while playing a game in the virtual gaming venue. The multi-media content management system or device 110 may also be configured to allow the players 104 present in one of the virtual gaming venues to play a separate instance of the game concurrently. For example, more than one player can play a same game with other users or alone on their respective phones at a same time. The multi-media content management system or device 110 may also be configured to allow the one or more of the players 104 to resume the at least one game on one or more of the computing devices 102a-102n. In an embodiment, the multi-media content management system or device 110 is configured to allow a player of the players 104 to resume the at least one game on more than one computing devices 102a-102n, where the more than one computing devices 102a-102n have different associated device identifiers and are present at different locations. For example, two friends playing a game and one receives a call and want to leave and resume it on next time so next time system automatically detects their devices and ask them whether they want to resume or start a new one.

In another embodiment, the gaming sever also have a resume capability of previous games played on devices by identifying the various computing devices, whether in past it links to single player or multi player presence. For example, two friends playing a game and one receives a call and want to leave and resume it on next time so next time system automatically detects their devices and ask them whether they want to resume or start a new one.

The multi-media content management system or device 110 may be implemented on multiple server present at different location that can work only on single entity which is the disclosed game server or the server like XYZ is our system's name and it is present in various locations with same game server and device, and have a resume capability with automatic identification of user. So whether a user goes in same parlor or any other location gaming system will ask him to “If he wants to resume his old game or start a new one” independent of user's location.

The multi-media content management system or device 110 may also be configured to manage scoring data of the players 104 by gathering scoring data or a game score for each of the players 104 during a playing of the at least one game (or a game play) in the virtual gaming venue. The multi-media content management system or device 110 may also be configured to compute a leaderboard data based on the managed scoring data of the players 104. The leaderboard data may include an arrangement of the players 104 in either an ascending or descending order based on the game score of each of the players 104. The leaderboard data may also indicate the players 104 who are lagging behind in the game play, and who are ahead of other players 104 in at least one game based on their scoring data. The multi-media content management system or device 110 may also be configured to display the leaderboard data at a display (not shown) of each of the computing devices 102a-102n in real-time.

In an embodiment, the multi-media content management system or device 110 may also be configured to aggregate a game score of each of the players 104 for multiple games played by each of the players 104 on the computing devices 102a-102n. The multi-media content management system or device 110 may also be configured to aggregate the scoring data of each of the players 104 for a pre-defined time interval such as, hourly, weekly, monthly, yearly, and so forth. The multi-media content management system or device 110 also uses or manages the aggregated scoring data of each of the players 104 for at least one gaming contest. The at least one gaming contest may involve one or more of the players 104. The gaming contests may include weekly contests, monthly contests, and so forth.

The multi-media content management system or device 110 is also configured to authenticate an identity of each of the computing devices 102a-102n based on a unique device identifier associated with the each of the computing devices 102a-102n.

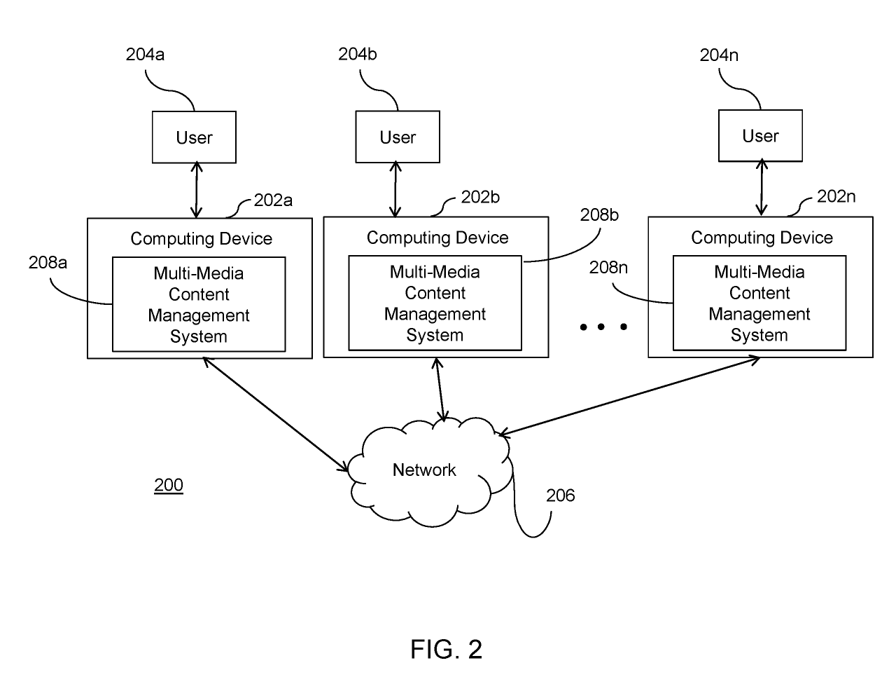

FIG. 2 illustrates another exemplary environment 200 for managing multi-media content on a number of computing devices 202a-202n in a network 206, in accordance with another embodiment of the present disclosure. The environment 200 may include a number of users 204a-204n having at least one of the computing devices 202a-202n. The computing devices 202a-202n (hereinafter 202) may include at least one of a number of multi-media content management systems 208a-208n (hereinafter 208). The computing devices 202a-202n may interact with each other via the network 206.

Each of the multi-media content management system 208 may allow the users 204a-204n to interactively play a game with each other in real-time in a virtual gaming venue. The users 204a-204n (hereinafter 204) can access the multi-media content management system 208 via the network 206. Hereinafter, the users 204a-204n may be collectively referred as the users 204 or players 204.

The multi-media content management system 208 may be configured to manage multiple virtual gaming venues including at least one lobby where multiple players or users 204 can play at least one game. Each of the players or users 204 can access one or more of the virtual gaming venues on their associated computing device 202. The virtual gaming venue is a virtual environment, which is available to the players or users 204 for playing one or more games in the network 206.

The multi-media content management system 208 may also be configured to allow the players 204 to interact and compete with each other while playing a game in the virtual gaming venue. The multi-media content management system 208 may also be configured to allow the players 204 present in one of the virtual gaming venues to play a separate instance of the game concurrently.

The multi-media content management system 208 may also be configured to manage scoring data of the players 204 by gathering scoring data for each of the players 204 during a game play in the virtual gaming venue. The multi-media content management system 208 may also be configured to compute a leaderboard data based on the scoring data of the players 204. The leaderboard data may arrange the players 204 in an ascending or descending order based on their scoring data. The leaderboard data may also indicate the players 204 who are lagging behind in the game play, and who are ahead of other players 204 or users in the game. The multi-media content management system 208 may also be configured to display the leaderboard data at a display (not shown) of each of the computing devices 202 in real-time.

The multi-media content management system 208 may also be configured to aggregate the scoring data of each of the players 204 for multiple games played by each of the players 204 on the computing devices 202. The multi-media content management system 208 may also be configured to aggregate the scoring data of each of the players 204 for a pre-defined time interval such as, weekly, monthly, yearly, and so forth. The multi-media content management system 208 also uses the aggregated scoring data of each of the players 204 for one or more gaming contests. The gaming contests may involve more than one of the players 204. The gaming contests may include weekly contests, monthly contests, and so forth.

In some embodiments, the multi-media content management system 208 may be configured to present multi-media interactive content on the computing devices 202. Further, the multi-media content management system 208 may present isolated and unique multi-media content such as, but not limited to, gaming content, for multiple virtual gaming venues in an interactive gaming environment on the computing devices 202. Each of the virtual gaming venues may also include at least one lobby where a number of games may be played or accessed by multiple users 204 on their respective computing devices 202. Further, one or more of the players or users 204 present in one of the multiple virtual gaming venues can play at least one game with other players or users 204 present in the same virtual gaming venue.

In some embodiments, the multi-media content may include advertisements, game updates, and scoring data of multiple users or players 204, and so forth. The functioning of the multi-media content management system 208a-208n is similar to the multi-media content management system 110 as described with reference to FIG. 1.

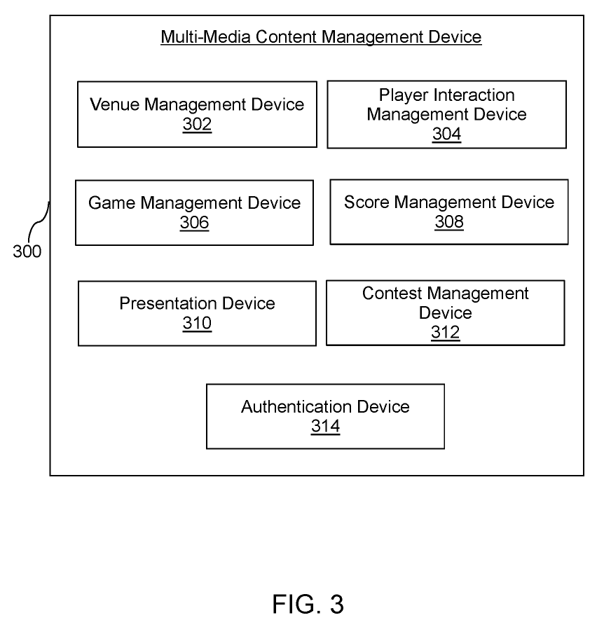

FIG. 3 is a block diagram that illustrates structural components of an exemplary multi-media content management system or device 300, in accordance with an embodiment of the present disclosure. The multi-media content management device or system 300 may primarily include a venue management device 302, a player interaction management device 304, a game management device 306, a score management device 308, a presentation device 310, a contest management device 312, and an authentication device 314.

The multi-media content management system or device 300 may allow a number users or players such as the users 104 to interactively play a game with each other in real-time in a virtual gaming venue. The venue management device 302 may be configured to manage multiple virtual gaming venues including at least one lobby where multiple players can play at least one game. The lobby may enable the users/players 104 to play at least one game on the computing devices 102a-102n, such as smart phones. The lobby may be a digital waiting area where the users 104 can be grouped up to play a game. The lobby may allow a set of the users 104 to play a same game at the same time and to compete with each other for the highest score. Each of the lobby may cycle through different games, with periods of breaks in between each lobby session. The lobby may be unique per location and may exist for each virtual gaming venue. Each of the players 104 access one or more of the virtual gaming venues on their associated computing device. The virtual gaming venue is a virtual environment, which is available to the players 104 for playing one or more games in a network (such as the network 106).

The venue management device 302 is further configured to represent each of players 104 using at least one virtual player in the at least one lobby. The at least one virtual player is a pre-defined virtual player. Further, each of the players 104 may select the at least one virtual player in real-time.

The player interaction management device 304 may be configured to enable the plurality of players 104 to interact and compete with each other while playing the at least one game in at least one virtual gaming venue.

The game management device 306 may be configured to allow the players or users 104 that are present in the at least one virtual gaming venue to play a separate instance of the at least one game concurrently. The game management device 306 is further configured to allow the one or more of the players 104 to resume the at least one game on one or more of the computing devices 102a-102n. Further, the game management device 306 may be configured to allow each of the players 104 to resume the at least one game on more than one of the computing devices 102a-102n. In an embodiment, the more than one of the computing devices 102a-102n have different associated device identifiers and are present at different locations. Example of the device identifier may include, but is not limited to, an International Mobile Equipment Identity (IMEI).

The score management device 308 may be configured to manage scoring data of the players or users 104 by gathering scoring data or a game score for each of the players 104 during playing of the at least one game in the virtual gaming venue. The score management device 308 may also be configured to compute a leaderboard data based on the managed scoring data or the game score of the players 104. The leaderboard data may arrange the players 104 in an ascending or descending order based on game score of the players 104 or the scoring data. The leaderboard data may also indicate the players 104 who are lagging behind in the game play, and who are ahead of other players 104. The score management device 308 may also be configured to aggregate a game score of the each of the players 104 for a number of games played by the players 104 on the computing devices 102a-102n. The score management device 308 may also be configured to aggregate the game score of the each of the players 104 for a pre-defined time interval, such as, but not limited to, weekly, hourly, monthly, yearly, and so forth.

In some embodiments, the score management device 308 is configured to capture behavioral data of the at least one virtual player being controlled by each of the players 104 during the playing of the at least one game based on a response of each of the players 104 in at least one virtual situation presented during the playing of the at least one game. The score management device 308 may be configured to analyze the captured behavioral data of the at least one virtual player to identify a player profile for the at least one virtual player.

The presentation device may be configured to display the leaderboard data at a display of each of the computing devices 102 in real-time. The score management device 308 may also be configured to aggregate the scoring data of each of the players 104 for multiple games played by each of the players 104 on the computing devices 102. The score management device 308 may also be configured to aggregate the scoring data of each player for a pre-defined time interval such as, weekly, monthly, yearly, and so forth. The presentation device 310 may also be configured to change a virtual gaming venue on at least one graphical user interface of at least one of the computing devices 102a-102n during playing of the at least one game in real-time based on the identified player profile for the at least one virtual player associated with at least one of the players 104.

The multi-media content management system or device 300 also includes the contest management device 312 for managing or using the aggregated scoring data of each of the players 104 for at least one gaming contest. The at least one gaming contest may involve more than one of the players 104. The gaming contests may include hourly contests, weekly contests, monthly contests, and so forth.

The multi-media content management system or device 300 also includes the authentication device 314 configured to authenticate an identity of each of the computing devices 102a-102n based on a unique device identifier associated with the each of the computing devices 102a-102n.

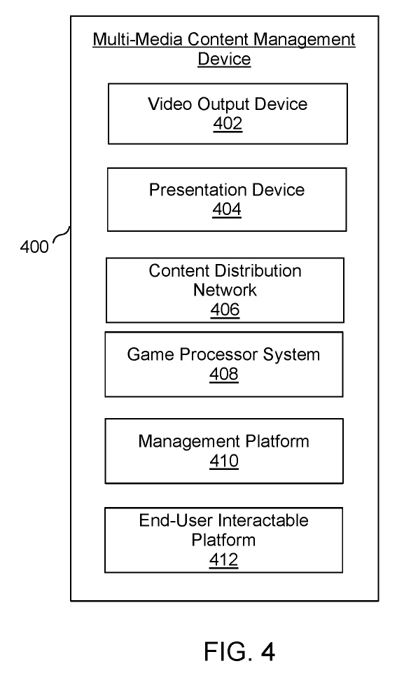

FIG. 4 is a block diagram that illustrates structural components of another exemplary multi-media content management system or device 400, in accordance with another embodiment of the present disclosure. The multi-media content management device 400 may primarily include a video output device 402, a presentation device 404, a content distribution network 406, a game processor system 408, a management platform 410, and an end-user intractable platform 412.

The video output device 402 is configured to display all content including games, advertising, and end-user performance reports, digital presentation to the users such as the users 104 and 204. The end user performance reports may be displayed on the video output device 402 or end-user interactable platform 412. Examples of the end-user performance report may include, but are not limited to, current rankings for a lobby session, current player points for a week, current player points for the month, and so forth. In some embodiments, the video output device 402 present the content on the computing devices 202 of the users 204. The digital presentation may include a set of slides and cutaways that may run in sequential or random order. A slide may be a presentation content item that has been prepared ahead of time, and stored in the content distribution network (CDN) 406. A cutaway may be a presentation content item that includes one or more slides, and may have dynamically generated content that is handled by the presentation device 404. The cutaway may be displayed on or by the video output device 402. This data (slides, cutaways etc.) may be packaged in common formats such as, but not limited to, HRML, XML, and so forth, or by using custom proprietary formats. The digital presentation may be configured in the management platform 410. The presentation content may be individual elements forming a slide or cutaway. Each of the element may consist of images, video, and text, either dynamically generated on demand or prepared in advance and stored within the CDN 406.

The computing devices 202 may be end-user devices used by the users 204 to access and play games within the virtual gaming venue. Examples of the computing devices 202 may include, but are not limited to, personal computers, mobile cellular phones, smart phones, tablet computers, laptop computers, and so forth. The games may be available in HTML5 or native applications running on the end-user consumer device. Multiple games are played in sequential order with periods of time or breaks in between each game session. Games may be used for a predetermined periods of time, where metrics are collected. Any metrics that are captured during the interaction (e.g. Scores, Points, etc.) may be sent to the lobbies through the game processor system (or device) 408.

The presentation device 404 may include a small computing device including a physical HDMI/S-Video/RCA/VGA/DVI video output interface. The presentation device 404 may also include an additional port for inserting a presentation input device (not shown). The presentation input device may be a generic input device capable of processing mouse or keyboard input. The input device may be connected via a wireless connection (such as Bluetooth®, ZigBee, radio frequency 4 for consumer electronics (RF4CE), Wi-MAX, and so forth) or physically tethered to device by wired connection. The presentation device 404 may be powered either by a wall power outlet, or via a USB cable in the video output device 402. The presentation device 404 may process the data prepared by the management platform 410 and downloaded from the content distribution network 406. The presentation device 404 may take the data and renders or display the digital presentation. The presentation device 404 needs to be configured, so that it can retrieve the correct data for a given user from the content distribution network 406.

The content distribution network (or CDN) 406 may serve static content from the network such as the Internet® in a performant manner to many end-users and video output device(s) 402. The content is usually created in the management platform 410 and uploaded into the content distribution network 406. Further, the digital presentation data may be stored in the CDN 406. The gaming assets may be made available to the users via the CDN 406.

The game processor system 408 may be responsible for managing player scoring information and game state for players in different lobbies of virtual gaming venues. The game processor system or device 408 may be capable of handling multiple lobbies and providing unique games to the end-user per virtual gaming venue.

The management platform 410 may allow select administrators to make changes to the content that will be displayed on the video output device 402. The management platform may also be configured to make changes to digital presentation and presentation data or content and subsequently make this data available in the CDN 406. The management platform may also include a content management system (CMS) for collecting scoring data from at least one lobby of at least one virtual gaming venue. The lobby may be a digital waiting area where the users 204 (or 104) are grouped up to play a game. The lobby may allow a set of the users 204 to play a same game at the same time and to compete with each other for the highest score. Each of the lobby may cycle through different games, with periods of breaks in between each lobby session. Lobbies may be unique per location and may exist for each virtual gaming venue. The CMS may also determine reward points for the players based on the number of players and the number of points or scoring data scored during a gaming session in the at least one lobby. Further, the reward points may be globally tracked in the network. This means the points or score points may not be unique to specific to a particular location. The CMS may use the score points for preparing end-user performance reports and for reconciling contest winners. Examples of the end-user performance report may include, but are not limited to, current rankings for a lobby session, current player points for a week, current player points for the month, and so forth. Further, the CMS may determine the reward points after completion of each gaming session of the at least one lobby. Further, the CMS may store and manage weekly/monthly reward points for each of the players along with location of the players.

The end-user interactable platform 412 may be an interface to the end-users (such as the users 104 or 204) for allowing them to play games and receive end-user performance reports. Examples of the end-user performance report may include, but are not limited to, current rankings for a lobby session, current player points for a week, current player points for the month, and so forth.

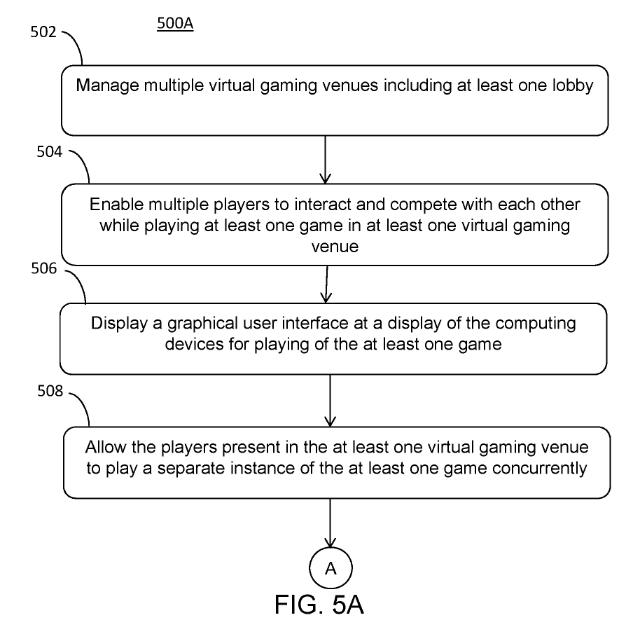

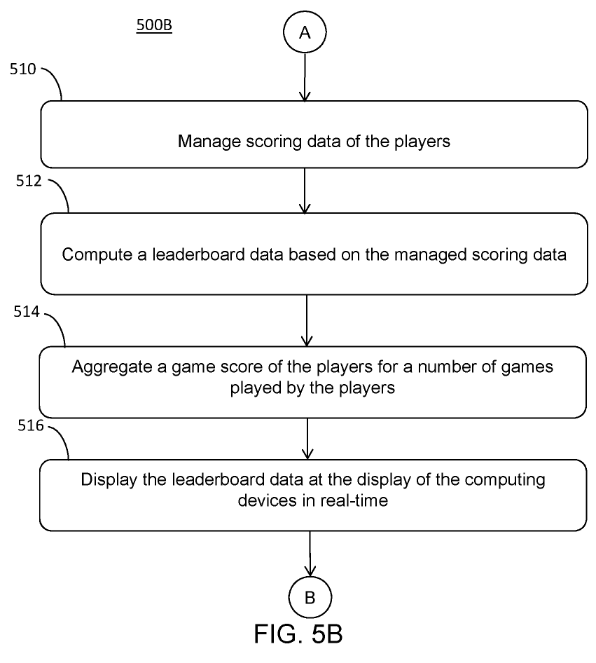

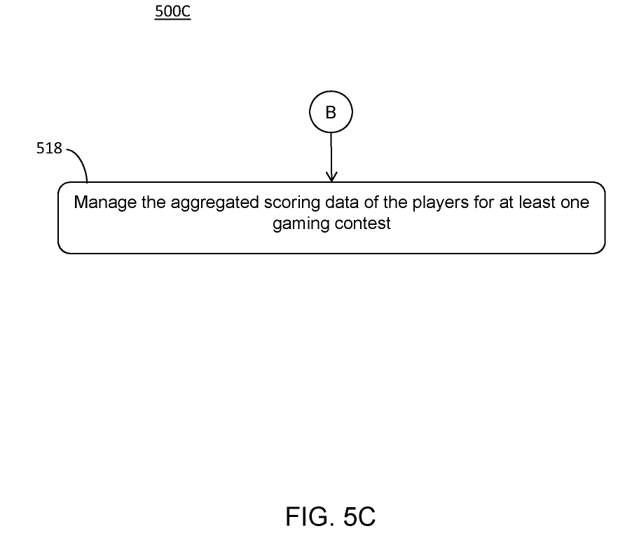

FIGS. 5A-5C is a flowchart illustrating a method 500 enabling a number of players, such as players 104 as discussed in FIG. 1, to interactively play at least one game in real-time on a number of computing devices, such as computing devices 102a-102n, associated with the players 104, in accordance with an embodiment of the present disclosure. As discussed with reference to FIG. 3, the multi-media content management system or device 300 may allow a number users or players such as the users/players 104 to interactively play a game with each other in real-time in a virtual gaming venue.

At step 502, multiple virtual gaming venues including at least one lobby are managed. In an embodiment, the venue management device 302 may be configured to manage the multiple virtual gaming venues including the at least one lobby where multiple players can play at least one game. The lobby may enable the users/players 104 to play at least one game on a number of computing devices, such as smart phones. The lobby may be a digital waiting area where the users 104 can be grouped up to play a game. The lobby may allow a set of the users 104 to play a same game at the same time and to compete with each other for the highest score. Each of the lobby may cycle through different games, with periods of breaks in between each lobby session. The lobby may be unique per location and may exist for each virtual gaming venue. Each of the players access one or more of the virtual gaming venues on their associated computing device. The virtual gaming venue is a virtual environment, which is available to the players for playing one or more games in a network (such as the network 106).

At step 504, the players 104 are enabled to interact and compete with each other while playing at least one game in at least one virtual gaming venue. In some embodiment, the player interaction management device 304 enables the players 104 to interact and compete with each other while playing the at least one game in the at least one virtual gaming venue. At step 506, a graphical user interface is displayed at a display of each of the computing devices 102a-102n for playing of the at least one game. In an embodiment, the presentation device 310 displays the graphical user interface at the display.

Then at step 508, players 104 present in the at least one virtual gaming venue are allowed to play a separate instance of the at least one game concurrently. In an embodiment, the game management device 306 allows the players 104 to play the separate instance of the at least one game concurrently. At step 510, scoring data of the players 104 is managed. In some embodiments, the score management device 308 manages the scoring data of the players or users 104 by gathering scoring data or a game score for each of the players 104 during playing of the at least one game in the virtual gaming venue. Then, at step 512, a leaderboard data is computed based on the managed scoring data. The score management device 308 may also be configured to compute a leaderboard data based on the managed scoring data or the game score of the players 104. The leaderboard data may arrange the players 104 in an ascending or descending order based on game score of the players 104 or the scoring data. The leaderboard data may also indicate the players 104 who are lagging behind in the game play, and who are ahead of other players 104.

At step 514, a game score of each of the players 104 for a number of games played at the computing devices 102a-102n is aggregated. In some embodiments, the score management device 308 is configured to aggregate the game score of the each of the players 104 for the games played by the players 104 on the computing devices 102a-102n. The score management device 308 may also be configured to aggregate the game score of the each of the players 104 for a pre-defined time interval, such as, but not limited to, weekly, hourly, monthly, yearly, and so forth.

Then at step 516, the leaderboard data is displayed at the display of the computing devices 102a-102n in real-time. In some embodiments, the presentation device 310 displays the leaderboard data at the display of the computing devices 102a-102n in real-time. Thereafter, at step 518, the aggregated scoring data of the players 104 is managed for at least one gaming contest. The at least one gaming contest may involve one or more of the players 104. The gaming contests may include hourly contests, weekly contests, monthly contests, and so forth.

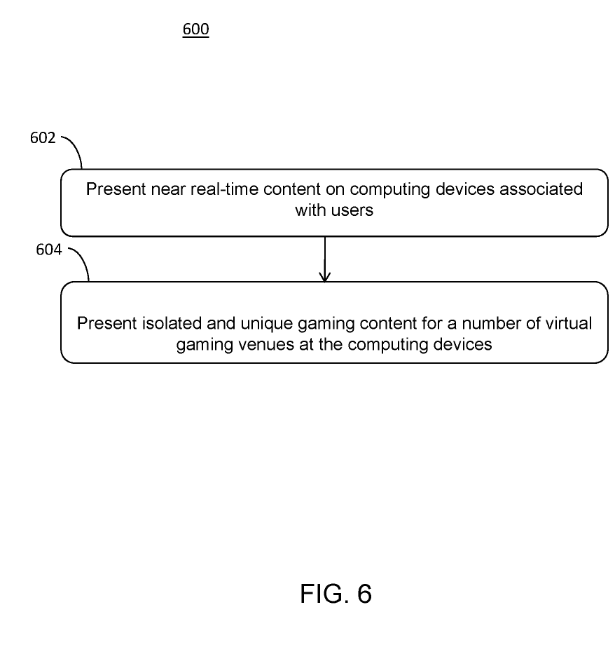

FIG. 6 is a flowchart illustrating a method 600 for presenting interactive multi-media content to one or more users, such as the users 104 of FIG. 1, in a network such as the network 106, in accordance with an embodiment of the present disclosure. As discussed with reference to FIG. 1, multiple users 104 can access multi-media content on their associated computing devices 102a-102n

At step 602, near real-time content is presented on a number of computing devices, such as the computing devices 102a-102n. The multi-media content may include advertisements, game updates, and scoring data of the multiple users 104. As discussed with reference to FIG. 3, the presentation device 310 may present the near real time content. Further, the near real-time content may include multimedia content such as, game related content.

At step 604, isolated and unique gaming content for a number of virtual gaming venues is presented on the computing devices 102a-102n. The virtual gaming venues may include at least one lobby where a number of games are being played or accessed by the users 104 on the computing devices 102a-102n. The at least one lobby may be a digital waiting area where the users 104 are grouped up to play a game of the plurality of games. One or more of the users 104 may be present in one of the virtual gaming venues plays at least one game with other users 104 present within the same virtual gaming venue. In an embodiment, the presentation device 310 presents the isolated and unique gaming content for the virtual gaming venues on the computing devices 102a-102n.

An embodiment of the present disclosure provides a multi-media content management system that allows a number of players to interactively play a game with each other in real-time in a virtual gaming venue. The multi-media content management system may include a venue management device configured to manage multiple virtual gaming venues including at least one lobby where multiple players can play at least one game. The lobby may be a digital waiting area where the users are grouped up to play a game. The lobby may allow a set of the users to play a same game at the same time and to compete with each other for the highest score. Each of the lobby may cycle through different games, with periods of breaks in between each lobby session. Lobbies may be unique per location and may exist for each virtual gaming venue. Each of the players access one or more of the virtual gaming venues on their associated computing device. The virtual gaming venue is a virtual environment which is available to the players for playing one or more games in a network. The multi-media content management system also includes a player interaction management device configured to allow the players to interact and compete with each other while playing a game in the virtual gaming venue. The multi-media content management system may also include a game management device configured to allow the players present in one of the virtual gaming venues to play a separate instance of the game concurrently. The multi-media content management system may also include a score management device configured to manage scoring data of the players by gathering scoring data for each of the players during a game play in the virtual gaming venue. The score management device may also be configured to compute a leaderboard data based on the scoring data of the players. The leaderboard data may arrange the players in an ascending or descending order based on their scoring data. The leaderboard data may also indicate the players who are lagging behind in the game play, and who are ahead of other players. The multi-media content management system may also include a presentation device configured to display the leaderboard data at a display of each of the computing devices in real-time. The score management device may also be configured to aggregate the scoring data of each player for multiple games played by each player on the computing device. The score management device may also be configured to aggregate the scoring data of each player for a pre-defined time interval such as, weekly, monthly, yearly, and so forth. The multi-media content management system also include a contest management device for using the aggregated scoring data of each of the players for one or more gaming contests. The gaming contests may involve more than one player. The gaming contests may include weekly contests, monthly contests, and so forth.

A further embodiment of the present disclosure provides a method for presenting multi-media interactive content on various computing devices connected to a network. The method includes presenting isolated and unique multi-media content such as, gaming content, for multiple virtual gaming venues in an interactive gaming environment on the computing devices. Each of the virtual gaming venues may also include at least one lobby where a number of games may be played or accessed by multiple users or players on their respective computing devices. Further, one or more of the players or users present in one of the multiple virtual gaming venues can play at least one game with other players present in the same virtual gaming venue.

Another embodiment of the present disclosure provides a multi-media content presentation system. The multi-media content may include gaming content. The system includes a presentation device for presenting near real-time content on a number of computing devices associated with a number of users. The presentation device is also configured to present isolated and unique gaming content for multiple virtual gaming venues in an interactive gaming system. Each of the virtual gaming venues may also include at least one lobby where a number of games may be played or accessed by multiple users on their respective computing devices. The lobby may be a digital waiting area where the users are grouped up to play a game. The lobby may allow a set of the users to play a same game at the same time and to compete with each other for the highest score. Each of the lobby may cycle through different games, with periods of breaks in between each lobby session. Lobbies may be unique per location and may exist for each virtual gaming venue. Further, one or more of the players present in one of the multiple virtual gaming venues can play at least one game with other players present in the same virtual gaming venue.

A yet another embodiment of the present disclosure provides a method for presenting interactive multi-media content to one or more users in a network. The method may include presenting near real-time content on a number of computing devices associated with the users or players. The multi-media content may include advertisements, game updates, and scoring data of multiple users.

A further embodiment of the present disclosure provides an interactive multi-media content presentation system. The system includes a presentation device configured for presenting near real-time content on a number of computing devices associated with a number of users. The multi-media content may include advertisements, game updates, and scoring data of multiple users or players.

Embodiments of the present disclosure provide methods and systems for allowing players to interactively play a game in real-time in a virtual gaming venue. The players can interact with each other while playing the game in the venue on their computing devices. Further, players in the venue can play a separate instance of the game concurrently without effecting other players. The method includes gathering a scoring data for the players during a game play in the venue. The scoring data of the players during a game play in the venue. The scoring data of the players may be used to computer a leaderboard data. The method also includes displaying the leaderboard data at the computing device in real-time, and aggregating the scoring data of each player for multiple games played by the players. The method includes aggregating the scoring data of each player for a pre-defined time interval such as, weekly, monthly, yearly, and so forth, and using the aggregated scoring data of players for gaming contests.

In an embodiment, the disclosed systems and methods may be based on artificial intelligence (AI). In one implementation, the disclosed multi-media content sharing management system may include an artificial intelligence (AI) engine to track player attributes and game states of a given electronic game, such as a multiplayer electronic card game hosted by a virtual dealer. The virtual dealer may be embodied as a video, hologram, or robot. The AI engine may select speech and gestures for the virtual dealer based on the game states and player attributes. The player attributes may be retrieved from a player tracking system of the multi-media content sharing management system, from an identifier card carried by the player, and from machine perception of the player in real time. In an embodiment, the AI engine may determine emotions for the virtual dealer to portray, based on circumstances. Supported by the AI engine, the virtual dealer may personalize dialogue, provide information, and perform card and chip tricks. The AI engine may also animate a virtual player and select interactions between the virtual dealer and the virtual player based on game states and attributes of the human players.

In another embodiment, a distributed gaming platform is provided where mobile devices (e.g., a Smartphone) with motion sensors may be used as input controllers of a game. The distributed gaming platform may include a cloud-based gaming rules engine that may manage multiple players and the content for display in the game. The game output is displayed on any web-enabled display, which is physically distinct from the mobile device. Multiple players may simultaneously play the same game, or different games, in multiple geographic locations.

In another embodiment, a method of synchronizing a portable device with an online user account is provided. The method may include establishing a first connection between the portable device and an online application. The method may also include receiving data from the online application concerning the online user account, including a persona. The method may further include updating the portable device with a portable user account corresponding to the online user account, including the persona. The method may also include terminating the first connection between the portable device and the online application. The method may further include recording modifications to the portable user account on the portable device after terminating the first connection, establishing a second connection between the portable device and the online application. The method may further include uploading the modifications to the portable user account recorded on the portable device to the online application, and updating the portable user account according to modifications to the online user account performed by the online application to synchronize the portable user account with the online user account.

In an other embodiment, systems and methods are provided that facilitate a connected gaming experience for multiple players utilizing multiple disparate devices. A game service affords playing a game over a communication framework, which can include a wired and/or a wireless local area and wide area networks, as well as access to a global positioning system. The game service may allow users to play a game on multiple devices, seamlessly switching devices at desired times and locations. In addition, the game service affords community-driven development of a game, as well as customization, through the communication framework. The latter also facilitates exchange of various contents among players, and between a player and the game service: (a) news, (b) advertising, (c) alerts, and (d) participant's real-world positioning information. Real-world embedding into a game is facilitated by the game service in combination with global tracking information received through the communication framework.

In another embodiment, a non-transitory computer-implemented method for enhancing the experience of a first player controlling a first avatar in a computer game by causing a speaker to play a theme is disclosed. The non-transitory computer-implemented method includes the steps of: (a) causing a processor to determine a context for the first avatar based on a first avatar's location in a virtual world; (b) causing a processor to select a groove level responsive to characteristics of the first avatar's virtual location, wherein the groove level may be an indicative of one of an excitement and a tension level; (c) causing a processor to play, at a non-zero output level, through a speaker, a background theme based on the first avatar's location and the selected groove level; (d) causing a processor to receive first instructions from the first player, the first instructions causing the first avatar to play a first melody, the first melody being chosen by the first player from among a plurality of available melodies; (e) causing a processor to receive second instructions from a second player, the second instructions causing a second avatar to play a second melody, the second melody being chosen by the second player; and (f) causing a processor to transform the first melody in response to the background theme and to the second melody by carrying out one of melody transposition and tempo matching.

In another embodiment, systems and methods to provide graphical user interfaces in computer-implemented multiplayer games is provided. The graphical user interface may include a friends panel that is operable between a collapsed condition and an expanded condition. The friends panel may provide friends information display functionality, social network management functionality, and/or messaging functionality both in the collapsed condition and in the expanded condition. In the collapsed condition, the friends panel may comprise a friends bar that shows a row of friend cards or chiclets associated with respective friends of a host player associated with a displayed game instance, the friends bar being clear of a view of a virtual in-game environment shown in the game display, while the expanded friends panel may comprise a grid of friend cards or chiclets that functionally obscures the in-game environment.

The methods and systems disclosed above can be implemented offline i.e. without a network. For example, the methods and systems may be implemented in offline applications that may be installed or executed on a computing device.

In one embodiment, a system and method for integrating player tracking and cash access in a casino or other gaming environment is disclosed. One aspect of the present disclosure may allow for fund access and management wherein gaming machines, such as slot machines or on-line virtual gaming machines, may receive playable credits directly from a patron's banking or credit card account. Another aspect of the present invention disclosure relates to integrating player tracking and cash access transactions by allowing the players to provide a player tracking card for each financial transaction conducted in a gaming environment. In return, the casino issues gaming or bonus points to the players for allowing their transactions to be tracked. Yet another aspect of the present invention disclosure consolidates the players' financial account information into a single casino database. Players can subsequently credit or debit cash from the players' financial accounts using any associated customer identification cards or otherwise receive such credits in other forms that permit negotiations, including quasi-cash documents.

In an embodiment, a data analytics system for a video game (or a multi-media content management system) where a player can interact with the video game through an avatar representing his/her own persona within a virtual gaming environment is provided. The data analytics system may include a data gathering module, a game modifying module, and an analytics module. The data gathering module associated with the game may gather data about the behavior of the avatar under the control of the player in response to virtual situations presented to the player within the game. The analytics module may analyze the data collected by the data gathering module data to identify a player profile based on the gathered data relating to the behaviour of the avatar under the control of the player. The game modifying module may modify the virtual gaming environment based on the identified profile of the player or a group of players.

Further, in an embodiment, a gaming server is disclosed that may have an intelligent feature to identify various computing devices by their unique ids (ex. IMEI no. In case of smart phones, ssid) and no other authentication information needed like user id and password.

In another embodiment, the gaming sever also have a resume capability of previous games played on devices by identifying the various computing devices, whether in past it links to single player or multi player presence. For example, two friends playing a game and one receives a call and want to leave and resume it on next time so next time system automatically detects their devices and ask them whether they want to resume or start a new one.

Another embodiment of the present disclosure provides a different location based gaming parlor that can work only on single entity which is the disclosed game server or the server like XYZ is our system's name and it is present in various locations with same game server and device, and have a resume capability with automatic identification of user. So whether a user goes in same parlor or any other location gaming system will ask him to “If he wants to resume his old game or start a new one” independent of user's location.

Embodiments of the disclosure are also described above with reference to flowchart illustrations and/or block diagrams of methods, apparatus (systems) and computer program products. It will be understood that each block of the flowchart illustrations and/or block diagrams, and combinations of blocks in the flowchart illustrations and/or block diagrams, may be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the acts specified in the flowchart and/or block diagram block or blocks.

These computer program instructions may also be stored in a computer-readable memory that can direct a computer or other programmable data processing apparatus to operate in a particular manner, such that the instructions stored in the computer-readable memory produce an article of manufacture including instruction means which implement the acts specified in the flowchart and/or block diagram block or blocks. The computer program instructions may also be loaded onto a computer or other programmable data processing apparatus to cause a series of operations to be performed on the computer or other programmable apparatus to produce a computer implemented process such that the instructions which execute on the computer or other programmable apparatus provide steps for implementing the acts specified in the flowchart and/or block diagram block or blocks.

In addition, methods and functions described herein are not limited to any particular sequence, and the acts or blocks relating thereto can be performed in other sequences that are appropriate. For example, described acts or blocks may be performed in an order other than that specifically disclosed, or multiple acts or blocks may be combined in a single act or block.

While the invention has been described in connection with what is presently considered to be the most practical and various embodiments, it is to be understood that the invention is not to be limited to the disclosed embodiments, but on the contrary, is intended to cover various modifications and equivalent arrangements.

What is claimed is:

1. A multi-media content management system for enabling a plurality of players to interactively play at least one game with each other in real-time on a plurality of computing devices associated with the plurality of players, the system comprising:
a venue management device configured to manage a plurality of virtual gaming venues including at least one lobby, wherein the at least one lobby enables the plurality of players to play the at least one game on the plurality of computing devices;
a player interaction management device configured to enable the plurality of players to interact and compete with each other while playing the at least one game in at least one virtual gaming venue of the plurality of virtual gaming venues;
a game management device configured to allow the plurality of players present in the at least one virtual gaming venue to play a separate instance of the at least one game concurrently;
a score management device configured to:
manage scoring data of the plurality of players by gathering a game score for each of the plurality of players during playing of the at least one game;
compute a leaderboard data based on the managed scoring data, wherein the leaderboard data comprises an arrangement of the plurality of players in at least one of an ascending and a descending order based on the game score of each of the plurality of players; and
aggregate a game score of the each of the plurality of players for a plurality of games played by the plurality of players on the plurality of computing devices;
a presentation device configured to:
display a graphical user interface at a display of the plurality of computing devices for playing of the at least one game; and
display the leaderboard data at the display of the computing device associated with each of the plurality of players in real-time; and
a contest management device for managing the aggregated scoring data of each of the plurality of players for at least one gaming contest, wherein the at least one gaming contest involves one or more players of the plurality of players.

2. The multi-media content management system of claim 1 further comprising an authentication device configured to authenticate an identity of each of the plurality of computing devices based on a unique device identifier associated with the each of the plurality of computing devices.

3. The multi-media content management system of claim 1, wherein the score management device is further configured to aggregate the game score of the each of the plurality of players for a pre-defined time interval.

4. The multi-media content management system of claim 1, wherein the game management device is further configured to allow the one or more players to resume the at least one game on one or more of the plurality of computing devices.

5. The multi-media content management system of claim 4, wherein the game management device is further configured to allow a player of the plurality of players to resume the at least one game on more than one computing devices, wherein the more than one computing devices have different associated device identifiers and are present at different locations.

6. The multi-media content management system of claim 1, wherein the venue management device is further configured to represent each of the plurality of players using at least one virtual player in the at least one lobby.

7. The multi-media content management system of claim 6, wherein the at least one virtual player is a pre-defined virtual player, wherein the plurality of players selects the at least one virtual player in real-time.

8. The multi-media content management system of claim 7, wherein the score management device is further configured to:
capture behavioral data of the at least one virtual player being controlled by each of the plurality of players during the playing of the at least one game based on a response of each of the plurality of players in at least one virtual situation presented during the playing of the at least one game; and
analyze the captured behavioral data of the at least one virtual player to identify a player profile for the at least one virtual player.

9. The multi-media content management system of claim 8, wherein the presentation device is further configured to change a virtual gaming venue on at least one graphical user interface of at least one of the plurality of computing devices during playing of the at least one game in real-time based on the identified player profile for the at least one virtual player.

10. A method for enabling a plurality of players to interactively play at least one game in real-time on a plurality of computing devices associated with the plurality of players, the method comprising:
managing, by a venue management device, a plurality of virtual gaming venues including at least one lobby, wherein the at least one lobby enables the plurality of players to play the at least one game on the plurality of computing devices;
enabling, by a player interaction management device, the plurality of players to interact and compete with each other while playing the at least one game in at least one virtual gaming venue of the plurality of virtual gaming venues;
displaying, by a presentation device, a graphical user interface at a display of the plurality of computing devices for playing of the at least one game;
allowing, by a game management device, the plurality of players present in the at least one virtual gaming venue to play a separate instance of the at least one game concurrently;
managing, by a score management device, scoring data of the plurality of players by gathering a game score for each of the plurality of players during playing of the at least one game;
computing, by the score management device, a leaderboard data based on the managed scoring data, wherein the leaderboard data comprises an arrangement of the plurality of players in at least one of an ascending and a descending order based on the game score of each of the plurality of players;
aggregating, by the score management device, a game score of the each of the plurality of players for a plurality of games played by the plurality of players on the plurality of computing devices;
displaying, by the presentation device, the leaderboard data at the display of the computing device associated with each of the plurality of players in real-time; and
managing, by a contest management device, the aggregated scoring data of each of the plurality of players for at least one gaming contest, wherein the at least one gaming contest involve one or more players of the plurality of players.

11. The method of claim 11 further comprising authenticating, by an authentication device, an identity of each of the plurality of computing devices based on a unique device identifier associated with the each of the plurality of computing devices.

12. The method of claim 11 further comprising aggregating, by the score management device, the game score of the each of the plurality of players for a pre-defined time interval.

13. The method of claim 11 further comprising, by the game management device, allowing the one or more players to resume the at least one game on one or more of the plurality of computing devices.

14. The method of claim 13 further comprising allowing, by the game management device, a player of the plurality of players to resume the at least one game on more than one computing devices, wherein the more than one computing devices have different associated device identifiers and are present at different locations.

15. The method of claim 11 further comprising representing, by the venue management device, each of the plurality of players using at least one virtual player in the at least one lobby.

16. The method of claim 15, wherein the at least one virtual player is a pre-defined virtual player, wherein the plurality of players selects the at least one virtual player in real-time.

17. The method of claim 16 further comprising:
capturing, by the score management device, behavioral data of the at least one virtual player being controlled by each of the plurality of players during the playing of the at least one game based on a response of each of the plurality of players in at least one virtual situation presented during the playing of the at least one game; and
analyzing, by the score management device, the captured behavioral data of the at least one virtual player to identify a player profile for the at least one virtual player.

18. The method of claim 17 further comprising changing, by the presentation device, a virtual gaming venue on at least one graphical user interface of at least one of the plurality of computing devices during playing of the at least one game in real-time based on the identified player profile for the at least one virtual player.

19. A method for presenting interactive multi-media content to one or more users in a network, comprising:
presenting, by a presentation device, near real-time content on a plurality of computing devices associated with the one or more users, wherein the multi-media content comprising advertisements, game updates, and scoring data of multiple users; and
presenting, by the presentation device, isolated and unique gaming content for a plurality of virtual gaming venues including at least one lobby where a plurality of games being played or accessed by the plurality of users on the plurality of computing devices, wherein the at least one lobby is a digital waiting area where the plurality of users are grouped up to play a game of the plurality of games, further wherein one or more of the plurality of users present in one of the plurality of virtual gaming venues plays at least one game with other users present within the same virtual gaming venue.

20. A multi-media interactive content presentation system, comprising:
a presentation device configured to:
present near real-time content on a plurality of computing devices associated with a plurality of users; and
present isolated and unique gaming content for a plurality of virtual gaming venues including at least one lobby where a plurality of games being played or accessed by the plurality of users on the plurality of computing devices, wherein the at least one lobby is a digital waiting area where the plurality of users are grouped up to play a game of the plurality of games, further wherein one or more of the plurality of users present in one of the plurality of virtual gaming venues plays at least one game with other users present within the same virtual gaming venue.
